(19) United States
(12) Patent Application Publication
(10) Pub. No.: US 2013/0141914 A1
(43) Pub. Date: Jun. 6, 2013

(54) LED LAMP WITH CHANGEABLE LIGHT EFFECT

(71) Applicants: CHI-YUAN LAI, Tu-Cheng (TW); HAI-FANG SHAN, Foshan City (CN)

(72) Inventors: CHI-YUAN LAI, Tu-Cheng (TW); HAI-FANG SHAN, Foshan City (CN)

(73) Assignees: FOXCONN TECHNOLOGY CO., LTD., Tu-Cheng (TW); CHAMP TECH OPTICAL (FOSHAN) CORPORATION, Foshan (CN)

(21) Appl. No.: 13/531,593

(22) Filed: Jun. 25, 2012

(30) Foreign Application Priority Data
Dec. 5, 2011 (CN) 201110398328.X

(51) Int. Cl. F21V 21/14; F21S 4/00

(52) U.S. Cl. 362/249.03

(57) ABSTRACT

An LED lamp includes a first light device and a second light device. The first light device includes a first cover and a first light strip received in the first cover. The second light device included a second cover and a second light strip received in the second cover. The second light device is movably mounted to the first light device. A light emitting area of the second light strip of the second light device is changeable according to movement of the second light device relative to the first light device whereby a total light emitting area of the LED lamp is adjustable.

### TECHNICAL FIELD

The present disclosure relates to illumination, and more particularly, to an LED (light emitting diode) lamp having changeable light effect.

### DESCRIPTION OF RELATED ART

LEDs have many advantages, such as high luminosity, low operational voltage, low power consumption, compatibility with integrated circuits, easy driving, long term reliability, and environmental friendliness. Such advantages have promoted the wide use of LEDs as a light source. Nowadays, LED lamps are commonly applied in general lighting. However, the LED lamps in different lighting spaces have different lighting requirements. Generally, the LED lamp with small lighting field can meet the lighting requirement of a small space, and the LED lamp with large lighting field can meet the lighting requirement of a large space. However, light sources of the typical LED lamp is often fixed. Thus, the lamp is difficult to satisfy different lighting requirements for spaces of different sizes.

What is needed, therefore, is an LED lamp having changeable light effect to overcome the above described shortcomings.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric, assembled view of an LED lamp in accordance with a first embodiment of the present disclosure.

FIG. 2 is similar to FIG. 1, but shows a second light device pulled out from a first light device of the LED lamp.

FIG. 3 is an enlarged view of a circled part III of FIG. 1.

FIG. 4 is an isometric, assembled view of an LED lamp in accordance with a second embodiment of the present disclosure.

FIG. 5 is similar to FIG. 4, but shows a second light device pulled out from a first light device of the LED lamp.

FIG. 6 is similar to FIG. 5, but shows the second light device separated from the first light device.

FIG. 7 is similar to FIG. 6, but from another aspect.

### DETAILED DESCRIPTION

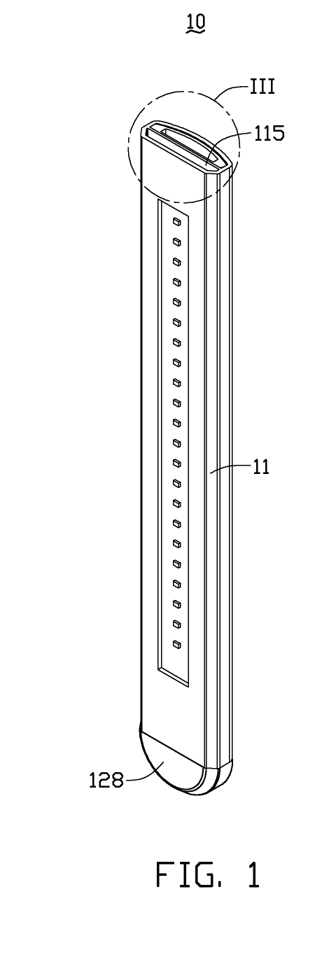

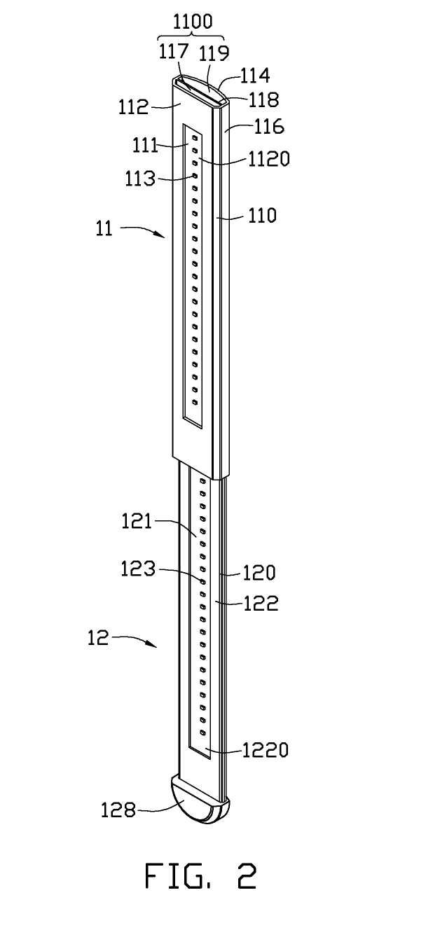

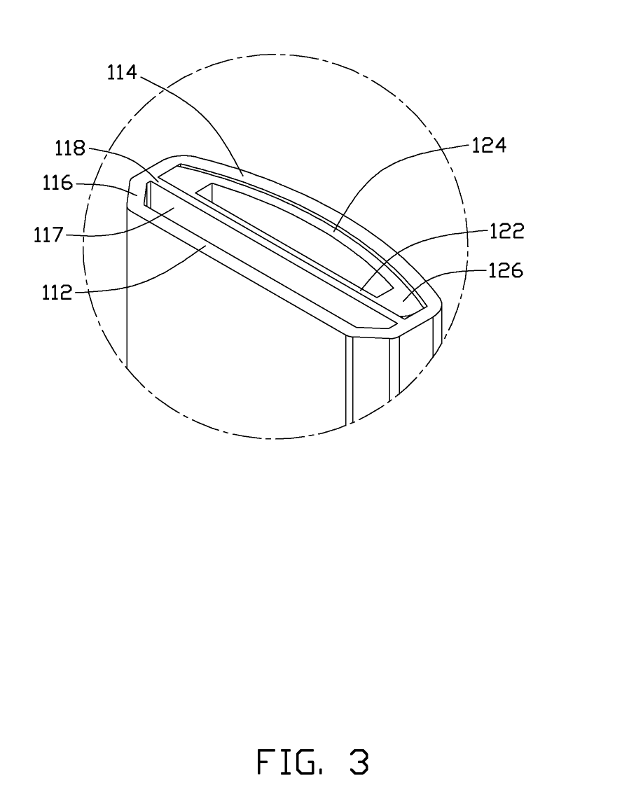

Referring to FIGS. 1-3, an LED lamp 10 in accordance with a first embodiment of the present disclosure is shown. FIG. 1 shows a retracted status of the LED lamp 10, FIG. 2 shows an extended status of the LED lamp 10. The LED lamp 10 includes a first light device 11 and a second light device 12 similar to the first light device 11. The he first light device 11 and the second light device 12 are both strip-shaped. The second light device 12 is installed inside the first light device 11 (shown in FIG. 1), and can be pulled out from the first light device 11 (shown in FIG. 2).

The first light device 11 includes a strip-shaped first cover 110 and a first light strip 111 received in the first cover 110. The first cover 110 is hollow with two opposite open ends. Alternatively, a top end 115 thereof can also be closed. The first cover 110 includes a front wall 112, a rear wall 114 and two side walls 116 interconnecting the front and rear walls 112, 114. A light transmission window 1120 is defined in a middle of the front wall 112. The first cover 110 further includes a dividing plate 118 formed in an inner chamber 1100 of the first cover 110. The dividing plate 118 connects two middles of the two side walls 116. The dividing plate 118 is parallel to the front wall 112. The dividing plate 118 divides the inner chamber 1100 of the first cover 110 into a first receiving space 117 adjacent to the front wall 112 of the first cover 110 and a second receiving space 119 adjacent to the rear wall 114 of the first cover 110. The first receiving space 117 is smaller than the second receiving space 119. The first light strip 111 is received in the first receiving space 117. The first light strip 111 includes a plurality of LEDs 113 exposed through the light transmission window 1120 of the front wall 112.

The second light device 12 includes a strip-shaped second cover 120 and a second light strip 121 received in the second cover 120. The second cover 120 includes a front wall 122, a rear wall 124 and two side walls 126 interconnecting the front and rear walls 122, 124. The second cover 120 is smaller than the second receiving space 119, and the second light device 12 is movably mounted in the second receiving space 119. A light transmission window 1220 is defined in a middle of the front wall 122. The second light strip 121 includes a plurality of LEDs 123 exposed through the light transmission window 1220 of the front wall 122. An operating portion 128 is formed on a bottom of the second cover 120. The operating portion 128 is semicircular and has a thickness equal to that of the first light device 11.

The second light device 12 is completely received in the second receiving space 119 except the operating portion 128 when the LED lamp 10 is in a retracted status. The operating portion 128 covers and abuts against the open bottom of the first cover 110. At this status, only the LEDs 113 of the first light device 11 are working, so the LED lamp 10 produces less light and form a relatively small light field. Thus, the LED lamp 10 can be used in a small space which does not need too much light. When the LED lamp 10 is required to be applied in a larger space, the second light device 12 is pulled out from the first light device 11 by pulling the operating portion 128 downwardly. A length of the second light device 12 exposed outside of the first light device 11 can be controlled by operating the operating portion 128, so that a number of the exposed LEDs 123 of the second light device 12 can be changeable. Only the exposed LEDs 1220 are working by photosensitive control or other control methods for energy saving. Thus, the LED lamp 10 has a changeable light effect to meet different lighting requirements. The operation to change the lighting effect of the LED lamp 10 is simple just by pulling the second light device 12 out from the first light device 11 or pushing the second light device 12 in the first light device 11.

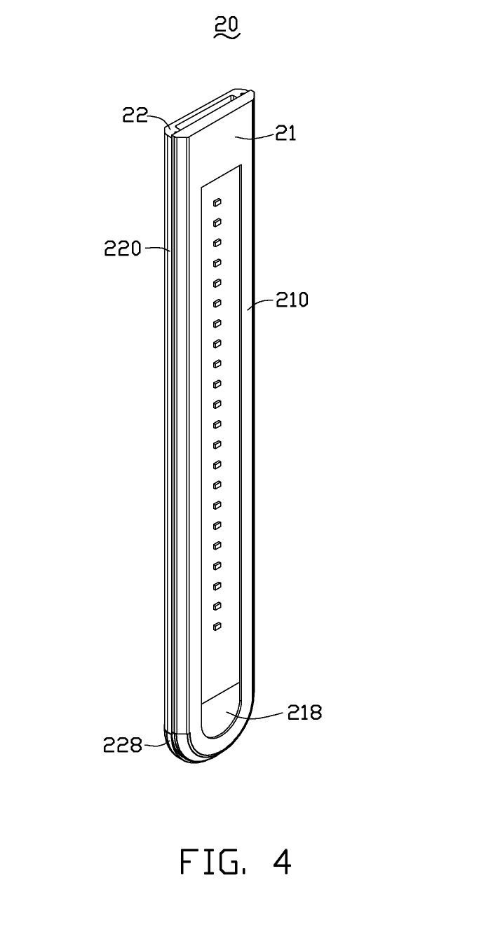

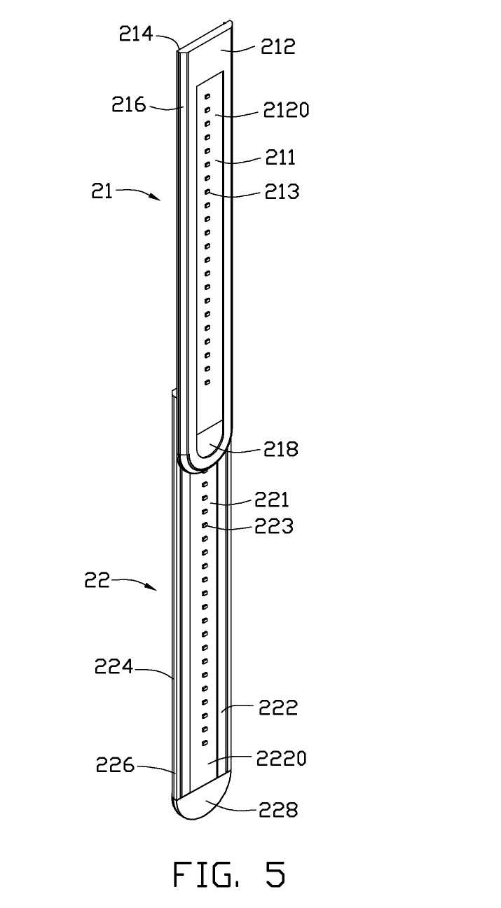

Referring to FIGS. 4-5, an LED lamp 20 in accordance with a second embodiment of the present disclosure is shown. FIG. 4 shows a retracted status of the LED lamp 20, and FIG. 5 shows an extended status of the LED lamp 20. The LED lamp 20 includes a first light device 21 and a second light device 22 similar to the first light device 21. The LED lamp 20 in this embodiment has a shape similar to that of the LED lamp 10 in the first embodiment. The first light device 21 includes a strip-shaped first cover 210 and a first light strip 211 received in the first cover 210. The first cover 210 includes a front wall 212, a rear wall 214 and two side walls 216 interconnecting the front and rear walls 212, 214. A semicircular operating portion 218 is formed on a bottom of the first cover 210. The operating portion 218 has a thickness equal to that of the first cover 210. A light transmission window 2120 is defined in a middle of the front wall 212. The first light strip 211 includes a plurality of LEDs 213 exposed through the light transmission window 2120 of the front wall 212.

The second light device 22 includes a second cover 220 and a second light strip 221 received in the second cover 220. The second cover 220 includes two front walls 222, a rear wall 224 and two side walls 226 interconnecting the two front walls 222 and the rear wall 224. The two front walls 222 are connected to the two side walls 226, respectively. A light transmission hole 2220 is defined between the two front walls 222. The second light strip 221 includes a plurality of LEDs 223 exposed through the light transmission hole 2220 of the front wall 222. An operating portion 228 is formed on a bottom of the second cover 220. The operating portion 228 is similar to the operating portion 218 of the first light device 21 and has a thickness equal to a thickness of the second cover 220. The second light device 22 is mounted to the rear wall 214 of the first light device 21.

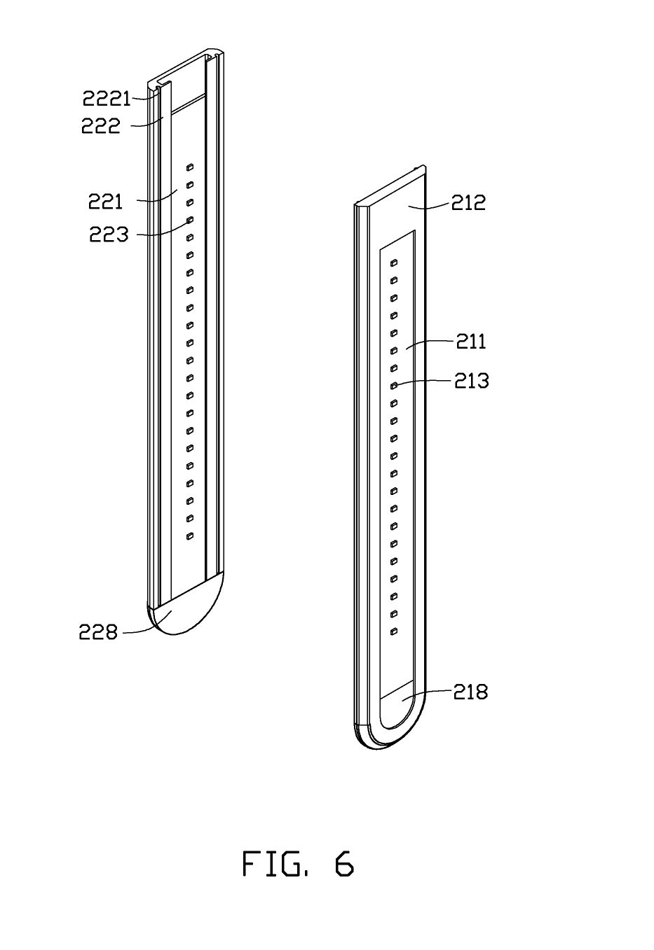

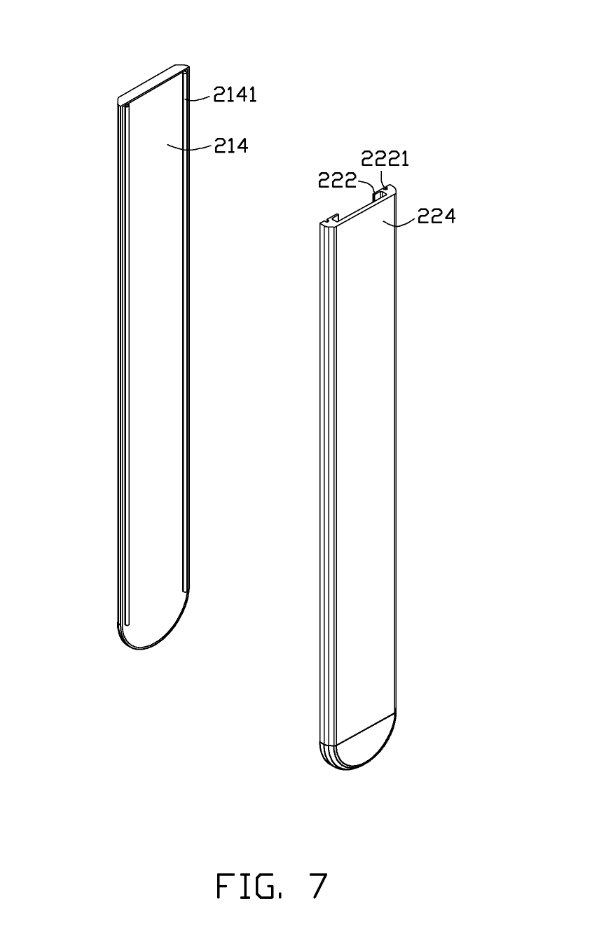

Referring to FIGS. 6-7, two sliding slots 2221 are defined respectively in the two front walls 222 of the second lighting device 22. The two sliding slots 2221 are extended from top ends of the front walls 222 to the operating portion 228 of the second light device 22. The two sliding slots 2221 are located near the two side walls 226, respectively. Two sliding bars 2141 are formed on the rear wall 214 of the first light device 21 corresponding to the two sliding slots 2221 of the second light device 22. The two sliding bars 2141 are extended from a top end of the rear wall 214 downwardly to a position corresponding to the operating portion 218.

The two sliding bars 2141 of the first light device 21 are received in the two sliding slots 2221 of the second light device 22, whereby the second light device 22 is movably mounted to the first light device 21. The second light device 22 is completely covered by the first light device 21 when the LED lamp 20 is used in a small space. At this status, only the LEDs 213 of the first light device 21 are working. When the LED lamp 20 is used in a larger space, the second light device 22 is exposed by pulling the operating portion 228 downwardly. Only the exposed LEDs 223 are working by photosensitive control or other control methods for energy saving. Thus, the LED lamp 20 has a changeable light effect to meet different lighting requirements. The operation to change the lighting of the LED lamp 20 is simple just by pulling the second light device 22 out from the first light device 11 or pushing the second light device 22 towards the first light device 11.

It is understood, the lengths of the first light device 11, 21 and the second light device 12, 22 can be different. The LED lamp 10, 20 can include more than two light devices. Besides sliding, the first light device 11, 21 can also be moved relative to the second light device 12, 22 through other methods such as rotation.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED (light emitting diode) lamp, comprising:
a first light device comprising a first cover and a first light strip received in the first cover; and
a second light device comprising a second cover and a second light strip received in the second cover;
wherein the second light device is movably mounted to the first light device, and a light emitting area of the second light strip of the second light device in total is changeable via movement of the second light device relative to the first light device.

2. The LED lamp of claim 1, wherein the second light device is movable between a retracted status where the second light strip of the second light device is substantially covered by the first light device, and an extended status where at least a light emitting part of the second light strip of the second light device is exposed out of the first light device.

3. The LED lamp of claim 2, wherein the light emitting area of the second light strip is an exposed area of the second light strip outside the first light device.

4. The LED lamp of claim 2, wherein the second cover is received in the first cover when the LED lamp is at the retracted status.

5. The LED lamp of claim 4, wherein the first cover is hollow and comprises a dividing plate dividing an inner chamber of the first cover into a first receiving space and a second receiving space, the first light strip is received in the first receiving space, and the second cover is received in the second receiving space.

6. The LED lamp of claim 5, wherein the first cover comprises an open end, and the second cover extends into the second receiving space through the open end.

7. The LED lamp of claim 6, wherein the second light device has an operating portion formed on the second cover, and the operating portion covers the open end of the first cover when the LED lamp is at the retracted status.

8. The LED lamp of claim 2, wherein the first light device has a similar shape to the second device.

9. The LED lamp of claim 8, wherein the first cover comprises a rear wall, the second cover comprises a front wall slidably mounted to the rear wall of the first cover.

10. The LED lamp of claim 9, wherein two sliding bars are formed on the rear wall of the first cover, and two sliding slots are defined in the front wall of the second cover to receive the two sliding bars, respectively.

11. The LED lamp of claim 10, wherein a first operating portion is formed at an end of the first cover, a second operating portion is formed at an end of the second cover, and the first operating portion is similar to the second operating portion.

12. The LED lamp of claim 11, wherein the second operating portion is completely covered by the first operating portion when the LED lamp is at the retracted status.

13. The LED lamp of claim 2, wherein the first cover comprises a first front wall and the second cover comprises a second front wall parallel to the first front wall of the first cover.

14. The LED lamp of claim 13, wherein a first light transmission window is defined in a middle of the first front wall, and a second transmission window is defined in a middle of the second front wall.

15. The LED lamp of claim 14, wherein the first light strip comprises a plurality of LEDs exposed through the first light transmission window, and the second light strip comprises a plurality of LEDs exposed through the second light transmission window.

16. The LED lamp of claim 15, wherein the first light transmission window and the second light transmission window are facing towards the same direction.

17. The LED lamp of claim 15, wherein only the LEDs of the second light device exposed outside the first light device and the LEDs of the first light device emit light when the LED lamp is turned on.

18. The LED lamp of claim 7, wherein the operating portion is semicircular.

19. The LED lamp of claim 11, wherein the first operating portion and the second operating portion are both semicircular.
